(19) United States
(12) Patent Application Publication
(10) Pub. No.: US 2017/0046454 A1
(43) Pub. Date: Feb. 16, 2017

(54) Base Reference System

(71) Applicant: Kevin WALLACE, Lake Grove, NY (US)

(72) Inventor: Kevin WALLACE, Lake Grove, NY (US)

(21) Appl. No.: 14/397,858

(22) PCT Filed: May 1, 2013
(86) PCT No.: PCT/IB2013/000799

§ 371 Date: Oct. 29, 2014

Related U.S. Application Data
(60) Provisional application No. 61/773,153, filed on Mar. 6, 2013.

(30) Foreign Application Priority Data
Apr. 25, 2012 (RU) 2012116606

(51) Int. Cl. G06F 17/50; G06Q 30/02

(52) U.S. Cl. CPC G06F 17/5004; G06Q 30/0241

(57) ABSTRACT

A base reference system for implementing a new form of proposed structure.

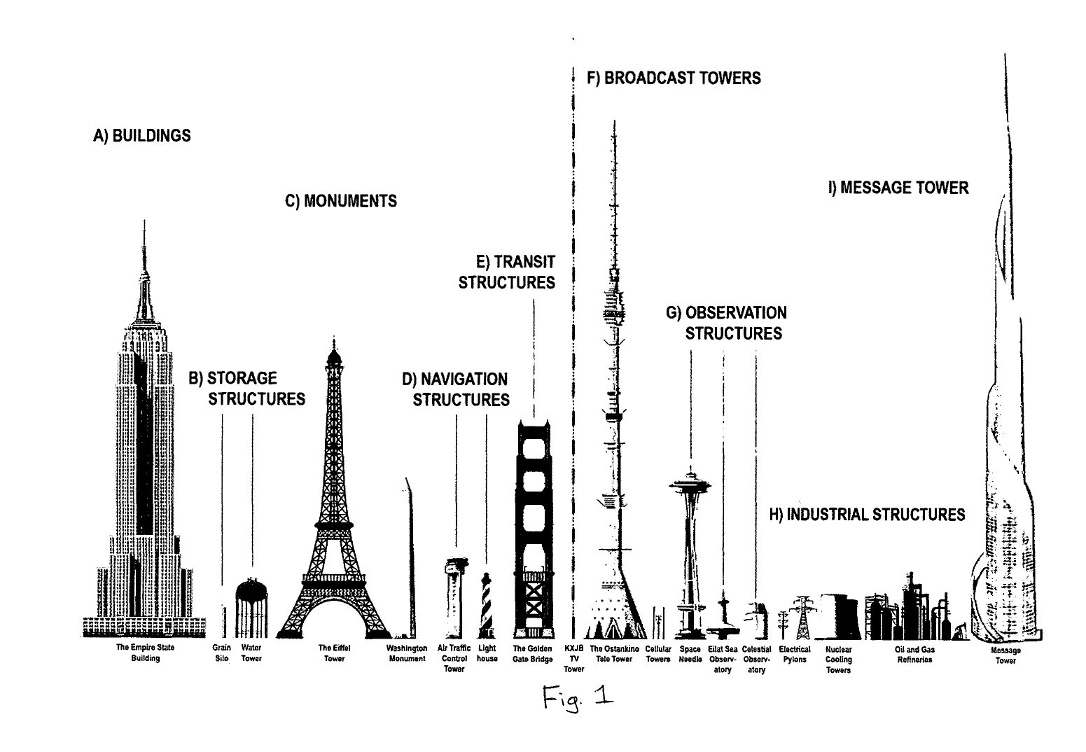

### CROSS-REFERENCE TO RELATED MATERIALS

US Patent Application Publication 2009/0234696 A1, US Patent Application Publication 2003/0208342 A1, US Patent Application Publication 2010/0062849 A1, U.S. Pat. No. 6,269,600 B1, U.S. Pat. No. 7,254,923 B2, U.S. Pat. No. 1,786,789, U.S. Pat. No. 5,659,475, U.S. Pat. No. 7,513,644 B2, U.S. Pat. No. 6,237,290 B1, U.S. Pat. No. 6,628,321 B1, U.S. Pat. No. 7,116,282 B2, US Patent Application Publication 2010/0299982 A1, US Patent Application Publication 2007/0194332 A1, US Patent Application Publication 2008/0248191 A1, Newsday article: WTC Plans Should Reach the Stars (2002) http://www.triroc.com/wtc/media/eliattia2.htm, USPTO Manual of Patent Examining Procedures, USPTO MPEP §2100, USPTO MPEP §2164 The Enablement Requirement, 37 CFR §1.475 Unity of invention, MPEP §1893.03(d) Unity of Invention, US case law Shine v Childs articles, Article: Mental Registration of 2D and 3D Visualizations (An Empirical Study), M. Tory, Wikipedia: Visual Perception, http://en.wikipedia.org/wiki/Visual_perception, Wikipedia: Gestalt Psychology, http://en.wikipedia.org/wiki/Gestalt_Psychology, Partnership for New York City Report, Grounded: The High Cost of Air Traffic Congestion, Harvard Business Services article: Just Show Me A Sign, http://blog.delawareinc.com/just-show-me-a-sign/, Harvard Business Services article: Are Trade Shows Worth the Expense?, http://blog.delawareinc.com/are-trade-shows-worth-the-expense/, Article: Curtain Wall Problems, Tips on Fabrication, Constructing and Testing, D. McCowan, M. Brown and M. Louis, Construction Lawyer Volume 28, Article: Architectural Design Process, http://architypes.net/pattern/design-process, eHow article: What are the Stages of Architectural Design?, http://www.ehow.com/how-does_4926841_what-stages-architectural-design.html, Wikipedia: Out-of-Home-Advertising, en.wikipedia.org/wiki/Out_of_home_advertising, Wikipedia: Billboard, en.wikipedia.org/wiki/Billboard, Today's Facility Manager: Services & Maintenance: Flight Plan, www.todaysfacilitymanager.com/articles/services-and-maintenance-flight-plan.php, ITech and Gadget Diary: Ornilux Bird Protection Glass: The Building Glass to Avoid Bird Collisions with Glass, www.itechdiary.com/ornilux-bird-protection-glass-the-building-glass-to-avoid-bird-collisions-with-glass.html, Article: The Saving of Ground Zero, A tale of power, money, tragedy, and the unlikely rebirth of the World Trade Center site: http://www.businessweek.com/magazine/the-saving-of-ground-zero-08032011.html, The Phoenix Declaration, http://www.petitiononline.com/fgh456/petition.html, Articles: TXu001783277 part 1 & part 2, (2012), 85459958, Rospatent Publication: Civil Code of the Russian Federation.

### REFERENCE TO SEQUENCE LISTING, TABLE, OR COMPUTER PROGRAMS

Custom MySQL database program at www.nyctoweroflight.com

### BACKGROUND OF THE INVENTION:

This invention relates to the development of a new form of proposed architectural structure, as well as innovative advancements for current architectural structures. More specifically, it relates to a base reference system to be used by a designer and/or entrepreneur with developers and/or investors, as a foundation tool or starting point for implementing and realizing the new form of proposed structure. More extensively, it relates to suggested methods of the business and operation of such a structure (*tshs), as well as suggested methods for assembling and building such a structure.

Disclosed is a pictorial and textual base reference system for a towering, architectural, visual-information apparatus. The pictorial and textual base reference system is herein abbreviated as simply the “base system.” The proposed towering, architectural, visual-information apparatus—to which the base system refers—is hereinafter abbreviated as a “message tower.” The base system may also be applied however to other pre-existing structures, or serve as a foundation for similarly innovative projects with alternative efficiencies.

The base system consists of a series of pictorial illustrations, images, charts, and other visual and instructional aids, as well as accompanying textual information provided within this disclosure, which also includes the citations referenced in the CROSS-REFERENCE TO RELATED MATERIALS listing on page 1.

The purpose of this base system is to serve as a foundational guide with which to build a message tower, or to convert an existing structure into a similarly stylized structure as a message tower. This base system will also enable any persons skilled in any of the related arts concerning a message tower to be able to utilize this base system as the foundational basis for building a message tower. This base system will also enable a designer and/or entrepreneur, as well as developers and/or investors, to speed up the work process and the decision-making processes, about design issues, marketing issues, and planning logistics, by enabling the end product and its potential revenue to be discerned faster, within fewer production steps than that which a traditional architectural project must undergo. The base system thereby ultimately saves time and money by enabling the structure to be realized faster, more efficiently, and in fewer functional steps than standard methods of producing architectural projects.

It is well known that architectural projects consist of several levels or phases of production and development, from the initial program requirements, to evaluation of a site, to schematic development, to city planning commission evaluations, to a developed design stage, to community board reviews, to developer approvals, to engineering evaluations, to architectural revisions, to developing construction documents and eventually, to a final executed design. Regardless of how many stages are involved however, unless there is a solid, well-developed initial design, preferably coupled with an equally well-developed functional and operational concept to serve as the foundational cornerstone of a project, all of the production expertise applied will be of little to no avail in creating genuine innovation or value for the project developers and/or investors. The precept stage is paramount to defining an architectural project's future success. This axiom may seem like common sense once you've read the foregoing paragraph—however—in fact, numerous urban planning projects go through the motions of starting with a poor foundation, and yet despite the obviousness of a poor foundation concept or design, continue to add layer upon layer, expense upon expense, to a poor foundation, in the blind hope that somehow, the project will transform into something other than what it started as. A perfect case in point was the horrendous folly of re-developing the World Trade Center in New York City in the aftermath of September 11th. Renowned architecture critic Ada Louie Huxtable had aplly referred to the decade-long morass. “The greatest panning fiasco in the history of the world.” The current problem with developing many urban projects is that often too many unncessary stages are imposed upon a project before developer(s) and/or investor(s) can accurately ascertain the potential success of a project.

This cornerstone precept of this base system is especially significant with regard to the proposed message tower architectural form because, as it will become clear from reading this full disclosure, a message tower is unlike any standard or normal building, and, the base system which sets it forth it to be presented is also a much different approach to getting a project off the ground.

The base system is not intended as a fully disclosed blueprint or a refined embodiment of the message tower in this initial filing; It is intended rather to serve as an indispensable foundational disclosure and the fundamental basis with which to enable persons skilled in related arts to be able to build upon, and to bring to further stages of development. [For example to give consideration to the refinement of costs, materials and labor that would in all likelihood be required to fully construct a message tower, or, in order to calculate any possible new zoning or building code requirements.] (The base system is also intended as a foundational disclosure with respect to other projects that developers and/or investors may wish to convert in a similarly stylized way as a message tower, such as incorporating similarly stylized aspects of a message tower into pre-existing structures, or incorporating them into new projects with alternative efficiencies.)

As a number of the drawings and images disclosed herein are simple 2-dimensional compositions, it is also significant to point out that architects routinely create construction drawings from 2d images. In fact, using 2d images is quite often the starting point with which to later translate such 2d images into refined construction documents—it is at the essence of what architects do.

Moreover, it should also be noted that there are both automated and semi-automated computer programs available, which after receiving 2-dimensional line drawings, formulate and deliver refined and advanced information in order to advance an architectural project forward.

### DESCRIPTION

A message tower is a proposed 3-dimensional sculptural marketing utility designed primarily for displaying illuminated information, imagery, advertisements, and other new media upon its entire 3-dimensional surface (or upon a substantial portion of its 3-dimensional surface), preferably in association with related trade show, entertainment, civic and commemorative events. The message tower is also presented as configurable structure with suggested multiple methods of assemblage, layout, operation and business.

A message tower may be built in a variety of sizes, though it is intended to tower over the heights of surrounding buildings, as to stand out and be seen from a distance; it may be seen from 6 to 10 miles away by the naked human eye, unaided by any visual enhancements.

A message tower also calls for an altogether novel and unprecedented classification of new structural utility, that embodies distinct differences from a normal building. Having such distinct differences from a normal building, it gives rise to the need for new zoning considerations in urban planning. As such, it might not be appropriately regarded as a standard building, though in the least it could be regarded as a highly unique innovation to a standard building or the fields of architecture and construction.

The primary purpose of a message tower is to display information, imagery and advertisements on a monumental towering scale, as opposed to the secondary function of providing habitable space.

### Originality of the Invention

One of the key novelties and unprecedented aspects of a message tower is that it displays in three dimensions on a soaring, monumental scale, thereby serving a highly novel purpose of offering a fully 3-dimensional means of displaying advertising and imagery, as opposed to the limited functionality of a 2-dimensional billboard, module, sheet, screen or similar façade. Whereas 2-dimensional billboards, modules, sheets, screens and similar façades have been employed for the purposes of advertising for centuries, there has never been a soaring monumental 3-dimensional illuminated message tower that can be seen from 6 to 10 miles away.

### Notes on Perceptional Differences Between 2d and 3d:

The very essence and perception of a 3-dimensional object is fundamentally and inherently different and distinct from the essence and psychological perception of a 2-dimensional object. The natural phenomena concerning this distinction has been the subject of many studies in Visual Perception, Gestalt Psychology, and other research concerning the analysis of human cognition and perception.

For example, a painting, a drawing, a photograph and a television screen are all 2-dimensional mediums for art and expression. A sculpture is a 3-dimensional work of art or expression. The essence and perception of a 3-dimensional sculpture is fundamentally and inherently different and distinct from the essence and perception of a 2-dimensional work.

Just as a television set or a computer monitor each consist of a 2-dimensional screen, if there were ever such an invention of a television set or a computer monitor that displayed information in 3-dimensions, it would be clearly be understood as something that is distinctly different from either a TV or a computer monitor.

### Non-Obvious Nature of a Message Ttower:

A message tower is not an obvious invention because it does not exist in the current landscape of modern society, nor has anything similar to it appeared in science fiction literature or film, and certainly not in the overall collective consciousness.

The message tower is not an extension of a billboard, because a billboard is a self-contained 2-dimensional device, which has no claim outside of its intended, manufactured, and practiced use.

A message tower is not an extension of a sign either, nor a module, nor a sheet, nor a screen.

Significantly, the common and instantaneous perception of a 2-dimensional sign, whether mounted on a building or a pole, is just that—a sign mounted on a building or a pole.

The instantaneous human psychological perception of a message tower being a 3-dimensional object is a result of its fully 3-dimensional nature.

A message tower is not perceived as an individual 2-dimensional module, nor as an individual 2-dimensional board, nor as a 2-dimensional sheet, nor a 2-dimensional sign, nor a 2-dimensional component.

Nor is a message tower perceived as a grouping of independent modules, or boards, or sheets, or signs, or components, but rather, again, it is instantly perceived as a towering, illuminated, 3-dimensional work, due to its 3-dimensional construct.

A recent and highly relevant case law analogy lends significant credence to the distinction between the psychological impression of a whole 3-dimensional object, versus any myriad of its individual or interchangeable components:

The current copyright law in the United States with regard to copyright protection of an individual architectural structure holds that, the individuality, and the protection of the individuality, of a specific architectural design is based on the immediate “total look and feel” of the overall 3-dimensional design, and the impression that the design as a whole creates in the mind of a viewer. (This was affirmed, upheld, and ruled upon in the recent 2005 judgment in the case of Shine v. Childs in Manhattan, N.Y.)

The significance of mentioning this ruling and analogy is that it supports the importance and veracity of human cognition perceiving a whole 3-dimensional object, versus the lesser significant and largely irrelevant issue of a myriad of interchangeable parts or components, such as windows, columns, mullions, spandrels, arches, trusses, steps, bricks, light bulbs, etc. . . . Although this legal analogy is from the realm of copyright law, the fact that the courts recognized such a distinction as a valid and determinate touchstone for confirming the significance of immediate human perception is highly significant and relevant to the subject at hand.

### BRIEF TECHNICAL DESCRIPTION OF THE INVENTION

The surface area of a message tower would be able to accommodate any, or any combination of, the following types of visual light-generating articles: Light Emitting Diodes (LEDs), Liquid Crystal Displays (LCDs), Surface-conduction Electron-emitter panels (SEDs), Organic Light-Emitting Diodes (OLEDs), Field Emission Display panels (FED)s, or high-definition plasma panels; however, the surface area of a message tower is by no means limited to these kinds of technologies.

### Eco-Versions of the Invention

Message towers could also accommodate solar panels and/or an array of micro wind turbines into portions of its surface area.

I claim:

1. A pictorial and textual base reference system for a towering visual-information apparatus.
